(19) United States
(12) Patent Application Publication
(10) Pub. No.: US 2006/0273756 A1
(43) Pub. Date: Dec. 7, 2006

(54) Opportunity charging system for battery powered mining equipment

(76) Inventors: David A. Bowling, Oak Hill, WV (US); Stephen A. Rudinec, Iron Mountain, MI (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/145,608

(22) Filed: Jun. 6, 2005

(51) Int. Cl. H02J 7/00

(52) U.S. Cl. 320/107

(57) ABSTRACT

An opportunity charging system for a battery-powered, mobile mining machine employs inductive power transfer for transferring battery charging current produced by a rapid charging station to the battery of the machine. An alignment module of the charging station automatically aligns primary coils of the charging station with pick-up coils carried by the machine in response to detection of the presence of the machine at the charging station. The charging station is located along roadways of the mine normally traveled by production equipment.

### BACKGROUND OF THE INVENTION

### Field of the Invention

The present invention relates generally to battery-powered mobile mining machines used in mining operations, and more particularly, to an opportunity charging system for charging the battery of a mobile mining machine “on the fly”.

Battery-powered mobile mining machines are commonly employed in underground mining operations. After a period of use, the battery on the mobile mining machine becomes drained of energy and must be replaced with a charged battery. Existing technology in the industry is to have a battery charging station in an area of the mine located away from the roadways normally traveled by the production equipment. At the charging station, the discharged battery must be removed from the mobile mining machine and connected to a battery charger. This is accomplished by special design, hydraulically operated apparatus on the mobile mining machine or by use of a forklift or scoop type mobile machine that is on the mining section. The connections between the battery and the mobile mining machine are large plugs and cables which require special tools to remove and are heavy and awkward to handle.

Battery-powered equipment used in underground mining typically uses a large storage battery to supply electric energy that can weigh in excess of 20,000 pounds. The ideal case is for a battery to last through at least one, eight hour shift of operation. At the end of the shift the discharged storage battery is taken to a battery charging station where it is removed from the mobile mining machine and connected to a battery charger. At that time a fresh, charged battery is installed on the mobile mining machine and the mobile mining machine is ready to go back into production. Depending on the distance to the battery charging station and the means used to remove the discharged battery from the mobile mining machine and replace the discharged battery with a fresh charged battery, this creates varying amounts of non productive, wasted time.

The charge cycle using existing technology is approximately eight hours. After charging the battery, an additional eight hours of “cool down” time is required before the battery can be placed back in service on the mobile mining machine. It is also common for mines to have an operating shift longer than eight hours and batteries have to be changed during the operating shift causing additional lost production time.

Inductive power transfer technology is used in the design of battery-powered, rail-mounted vehicles, electric battery operated buses, electric cranes and similar heavy equipment utilizing batteries for motive power or electric functions. It is used on a smaller scale to inductively charge computer batteries, cell phones and similar electronic devices. However, inductive power transfer technology has not been applied to mobile mining equipment to the knowledge of the inventors.

It is accordingly the primary objective of the present invention that it provide an opportunity charging system for battery-powered, mobile mining equipment.

It is another objective of the present invention that it provide an opportunity charging system that is fully automated.

A further objective of the present invention is that it provide an opportunity charging system for mining equipment that minimizes the amount of time required for maintaining battery in a charged condition.

Another objective of the present invention is that it provide an opportunity charging system for mining equipment that does not require making electrical connections between charging at a charging station and the battery being charged.

It is yet another objective of the present invention that it provide an automated, battery charging system that is computer controlled.

The opportunity charging system of the present invention must include apparatus of construction which is both durable and long lasting, and require little or no maintenance to be provided by the user throughout its operating lifetime. In order to enhance the market appeal of the apparatus of the present invention, the system should also be of inexpensive to implement, thereby affording it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, there is provided an opportunity charging system for providing rapid charging of a battery that provides electric power to move and operate battery powered mobile mining machines. The opportunity charging system allows the storage battery of a mobile mining machine to be recharged without removing the battery from the mobile mining machine and reduces the non-productive time required to change batteries. By way of example, the power transfer components of the opportunity charging system can provide battery charging times as low as twenty seconds.

In accordance with the invention, there is provided an opportunity charging system for a battery-powered mobile mining machine operating within a mine. The opportunity charging system includes at least one rapid charging station for charging the battery on the mobile mining machine using inductive power transfer. The rapid charging station is located in an area of the mine along a roadway traveled by the mobile mining machine. The rapid charging station includes at least one primary coil and a support for supporting the primary coil adjacent to a roadway over which the mobile machine travels. The rapid charging station further includes a power supply for energizing the primary coil and a controller. The mobile machine includes at least one pickup coil. The support allows the mobile machine to be driven to a position adjacent to the primary coil that permits the pick-up coil to be located in signal coupling relation with the primary coil. The mobile machine further includes a remote battery charging interface for allowing a communication link to be established between the mobile machine and the rapid charging station. The controller of the rapid charging station initiates battery charging cycles in response to information transmitted over the communication link.

Further in accordance with the invention, there is provided an opportunity charging system for a battery-powered mobile mining machine operating within a mine. The opportunity charging system includes at least one rapid charging station for charging the battery on the mobile machine using inductive power transfer. The rapid charging station includes a primary coil, a power supply for energizing the primary coil and a support for supporting the primary coil in overlying relationship with at least a portion of a roadway over which the mobile machine travels. The rapid charging station further includes a controller and an alignment module. The mobile machine includes a pick-up coil mounted on an upper surface of the mobile machine. The support allows the mobile machine to be driven to a position beneath the primary coil that permits the pick-up coil to be located in signal coupling relation with the primary coil. The mobile machine further includes a remote battery charging interface allowing a communication link to be established between the mobile machine and the rapid charging station. The controller of the rapid charging station initiates battery charging cycles in response to information transmitted over the communication link.

In accordance with another aspect of the invention, there is provided a method for providing opportunity charging of a battery of a battery-powered mobile mining machine operating within a mine. The method includes the steps of providing at least one rapid charging station for charging the battery on the mobile machine using inductive power transfer, wherein the charging station includes a primary coil and a power supply for supplying current to the primary coil. Supporting the primary coil in overlying relationship with at least a portion of a roadway over which the mobile machine travels. Providing a pick-up coil on the mining machine and coupling the pick-up coil to terminals of the battery through a rectifier circuit. Driving the mining machine into the charging station to locate the pick-up coils in close proximity with the primary coil. Detecting the presence of the mining machine in the charging station. Automatically initiating a charging cycle in response to detection of a mining machine in the charging station. Monitoring at least one parameter of the battery, and terminating the charging operation when the parameter reaches a predetermined value.

This invention provides a means to charge the storage battery on the mobile mining machine, while the mobile mining machine is in operation. The mobile mining machine does not have to be turned off. The mobile mining machine does not have to leave the production area of the section being mined and the operator does not have to leave his operating position on the mobile mining machine.

The reduced charging time allows increased production time which will result in a reduced cost per ton to mined product, making the mining operation more profitable.

Moreover, this invention eliminates shortcomings of the prior art battery charging arrangements for mobile mining equipment because the battery remains on the mobile mining machine, and there are no plugs or cables to disconnect, move and reconnect. The present invention keeps the battery in service, on the mobile mining machine at all times. This also makes the job of the operator of the mobile mining machine easier, more productive and safer. In accordance with the present invention, the opportunity charging system can employ at least three batteries for each mobile mining machine. One battery is used for in-service duty, one battery is used for charging and the third battery is used to allow for cool down following charging.

This opportunity charging system of the present invention makes use of existing inductive power transfer technology. What is unique to this invention is the method by which inductive technology will be adapted to mining equipment. To the knowledge of the inventors, this is the first application of the technology to mobile mining equipment.

It may therefore be seen that the present invention provides an opportunity charging system for battery-powered mobile mining machines that is fully automated and which minimizes the amount of time required for maintaining battery in a charged condition. The storage battery on the mobile mining machine is charged while the mobile mining machine is in operation. The mobile mining machine does not have to be turned off and the mobile mining machine does not have to leave the production area of the section being mined.

The opportunity charging system of the present invention employs apparatus of a construction which is both durable and long lasting, and which will require little or no maintenance to be provided by the user throughout its operating lifetime. The system of the present invention is also inexpensive to implement to enhance its market appeal, thereby affording it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 illustrates an underground mine with a plurality of rapid battery charging stations for allowing opportunity charging of batteries of a plurality of battery-powered, mobile mining machines operating within the underground mine;

FIG. 2 is a block diagram of the opportunity charging system provided by the present invention;

FIG. 3 is a top plan view of a battery-powered, mobile mining machine of the opportunity charging system in accordance with the present invention;

FIG. 4 is a side elevation view of the battery-powered, mobile mining machine of FIG. 3;

FIG. 5 is a representation of tolerances of relative positions of primary and pickup coils of the opportunity charging system of the present invention;

FIG. 6 is a simplified, end view of the battery-powered, mobile mining machine of FIG. 3 shown located in a rapid charging station of the opportunity charging system;

FIG. 7 is sketch a illustrating the locations of sensors for determining the distance between the top and the side of the mobile mining machine of FIG. 3 relative to the primary coils of the rapid charging station;

FIG. 8 is a sketch illustrating the location of a sensor for determining the distance between the front of the mobile mining machine of FIG. 3 relative to the primary coils of the rapid charging station; and

FIG. 9 is a process flow chart for the opportunity charging system in accordance with the invention.

### DETAILED DESCRIPTION OF THE PREFERRED EMBODIMENT

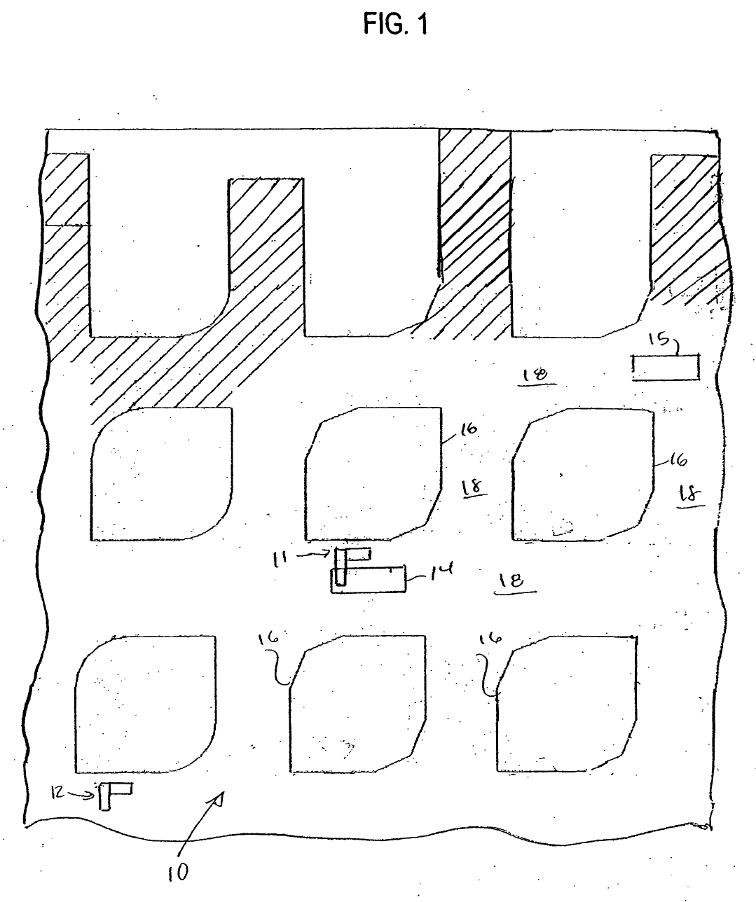

Referring to FIG. 1, the opportunity battery charging system provided by the present invention is described with reference to an application in a mining operation in a underground mine 10. One or more rapid charging stations, such as rapid charging stations 11 and 12, are provided within the mine for allowing opportunity charging of batteries of a plurality of battery-powered mobile mining machines, such as mobile mining machines 14 and 15, operating within the underground mine. Typically such mobile mining machines are loaded with material removed from mine faces at a location that is close to where the mine is being worked, and the mobile mining machines are driven to a discharge location where the load is discharged onto a conveyor, or other transport mechanism, for carrying the mined material out of the mine.

For purposes of illustration of the invention, the opportunity battery charging system provided by the present invention is described with reference to an application in a mining operation in an underground mine that is being mined using the room and pillar method. However, it will be apparent that the present invention can be used in a wide variety of mining operations. In such application, material is mined at mine faces to form rooms, with pillars 16 of the material remaining for support and defining roadways 18 through the mine for the mobile mining equipment, including the mobile mining machines 14 and 15, and other production equipment. The rapid charging stations 11 and 12 are located at the side of roadways 18, allowing recharging of the batteries of the mobile mining machines 14 and 15 as the mobile mining machines are driven through the mine 10. By way of example, the rapid charging stations 11 and 12 can be located close to the discharge location, allowing the battery of the mobile mining machine to be charged while the mobile mining machine is stopped while discharging its load. The battery will received a boost sufficient to carry the mobile mining machine back and forth between the work area and the discharge location. However, in cases where the mobile mining machine is required to travel extremely long distances, one or more rapid charging stations can be located along the way.

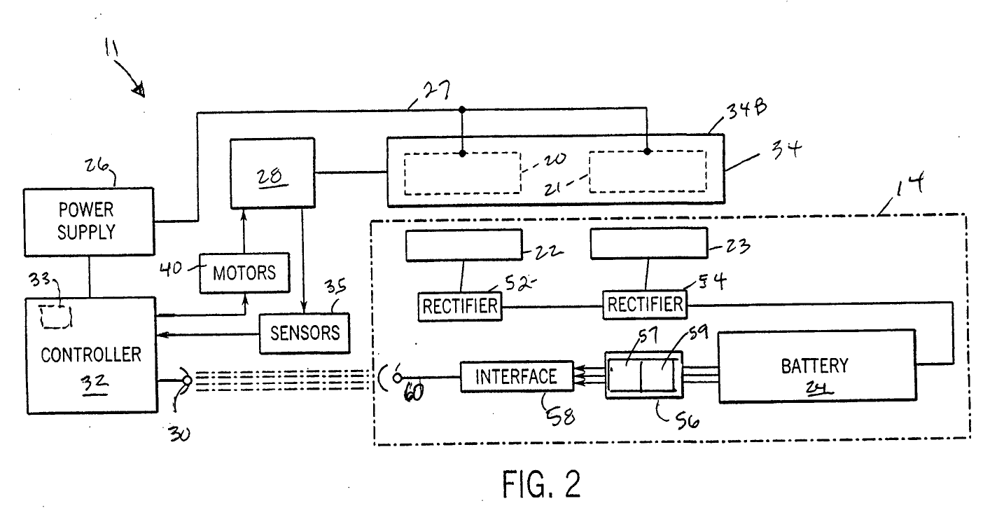

The opportunity charging system employs inductive power transfer for transferring battery charging current produced by the rapid charging station 11 to a battery of the mobile mining machine 14. Referring also to FIG. 2, to this end, each rapid charging station, such as rapid charging station 11, includes one or more primary coils, such as primary coils 20 and 21, and each mobile mining machine, such as mobile mining machine 14, includes one or more pick-up coils, such as pick-up coils 22 and 23. In accordance with the present invention, the rapid charging stations 11 and 12 are located in an area of the mine 10 along the roadways 18 normally traveled by the production equipment. For purposes of illustration, the rapid charging stations 11 and 12 are illustrated in FIG. 1 as being located relatively close together. However, the rapid charging stations would be dispersed within the mine at locations that are most accessible to the mobile mining machines 14 and 15, the batteries 24 of which are to be charged. The rapid charging stations can be moved. Although the rapid charging stations are installed to be immobile or fixed at the selected locations, the rapid charging stations can be portable units, facilitating relocation of the rapid charging stations to different locations as “working” of the mine proceeds.

Even with the opportunity charging system, there will be times when the battery 24 will have to be removed from a mobile mining machine, such as mobile mining machine 14, to allow a full “deep” charge of the battery 24 to extend battery life. To this end, a battery charging station (not shown) can be located in an area of the mine away from the roadways normally traveled by the production equipment. At the battery charging station, the discharged battery 24 is removed from the mobile mining machine and connected to a battery charger and a charged battery (not shown) can be installed on the mobile mining machine, allowing the mobile mining machine 14 to be returned to service while the battery 24 is being charged.

Opportunity Charging System

Referring to FIG. 2, there is shown a block diagram of a rapid charging station 11 and a mobile mining machine 14 of the opportunity charging system provided by the present invention. For purposes of illustration, reference is made to only rapid charging station 11 and mobile mining machine 14 in the following detailed description. However, the structure, function and operations disclosed refer equally to rapid charging station 12 and a mobile mining machine 15 as well as other rapid charging stations and mobile mining machines. As stated above, the opportunity charging system employs inductive power transfer for transferring battery charging current produced by the rapid charging station 11 to a battery 24 of the mobile mining machine 14.

In addition to the primary coils 20 and 21, each rapid charging station, such as rapid charging station 11, further includes a power supply 26, cables 27 connecting the power supply 26 to the primary coils 20 and 21, an alignment module 28, a signal modem 30 for communicating with the mobile mining machine 14, and a controller 32 which controls the operation of the rapid charging station. Preferably, the signal modem is an RF modem allowing wireless communication between the rapid charging station and the mobile mining machine. However, the modems can use frequencies other than those in the radio frequency band, including infrared frequencies. The rapid charging station further includes a support (represented by block 34) for supporting and positioning the primary coils adjacent to one of the roadways 18. Referring also to FIG. 6, the support 34 includes a vertical post 34A and a beam 34B supported by the post 34A in cantilever fashion extending horizontally. The primary coils are carried by the beam 34B, suspended above the roadway 18 at a height sufficient to allow the mobile mining machine 14 to be driven to a position beneath the primary coils 20 and 21, allowing the pick-up coils 22 and 23 to be located in signal coupling relation with the primary coils 20 and 21 to permit inductive power transfer between the primary coils and the pick-up coils during charging operations. The inductive pick-up coils and the primary coils do not make physical contact. There is an air gap of approximately 10 mm between the inductive pick-up coils and the primary coils. By way of example, the windings of the pick-up coils and the primary coils can have the same number of turns.

Alternatively, the post 34A can be adapted to be movable vertically up and down. The horizontal beam 34B can be raised to allow the mobile mining machine 14 to be driven to a position locating the pick-up coils below the primary coils, and then lowered during charging operations. The battery 24 will only be partially charged at the rapid charging station 11. Full charge will not be achieved except at those times that the battery is removed from the mobile mining machine, charged for several hours and allowed to cool.

The alignment module 28 includes plurality of location sensors 35 that are used in aligning the primary coils 20 and 21 of the rapid charging station 11 with the pickup coils 22 and 23 on the mobile mining machine 14. The sensors 35 can be ultrasonic sensors. The sensors 35 are used in determining the location of the mobile mining machine 14 relative to the rapid charging station 11. The alignment module 28 also includes a plurality of positioning motors 40 for causing the primary coils 20 and 21 to be repositioned along “x”, “y” and “z” axes, respectively, as needed, in aligning the primary coils with the pick-up coils. The primary coils are movable both vertically and horizontally, and angularly. The operator moves the mobile mining machine into position close to the primary coils and the alignment module “finds” the pick-up coils and aligns the primary coils to the pick-up coils. The pick-up coils are rigidly mounted on the mobile mining machine 14. The pick-up coils mounted on an upper surface of the mobile mining machine 14, but cannot be located at the highest point of the mobile mining machine for protection purposes. The mine top is often in close proximity to the top of the haulage equipment.

Each mobile mining machine, such as mobile mining machine 14, includes the pick-up coils 22 and 23, the battery 24, rectifier(s) 52 and 54, including a separate rectifier for each pick-up coil. Depending on the charge level required, additional pick-up coils (each with an associated primary coil and rectifier) can be used. The rectifiers 52 and 54 are connected in series. The rectifiers isolate the battery 24 from the pick-up coils when charging current is not being supplied.

The mobile mining machine 14 further includes a monitoring circuit 56, including a controller 57 and one or more monitoring devices for monitoring battery parameters such as battery temperature, voltage and electric current, and providing signal inputs to the controller 57, and a rapid charging interface 58 including a signal modem 60, all of which are mounted on the mobile mining machine 14. The signal modem 60 operates in the same frequency band as the signal modem 30.

Each of the rapid charging stations, such as rapid charging station 11, is fully automated and does not require a human operator. Preferably, the charging cycle is initiated and controlled by the controller 32 of the rapid charging station 11. Charge time will be determined by the processor of the remote charging station based on the information fed back from the monitoring on the machine. In order to rapid charge the battery on the mobile mining machine 14, the operator drives the mobile mining machine 14 into the area where the rapid charging station is located. The alignment system 28 of the rapid charging station 11 automatically aligns the primary coils 20 and 21 with the pick-up coils 22 and 23 on the mobile mining machine 14, causing the primary coils 20 and 21 to be moved horizontally, longitudinally and vertically, as needed to effect the coil alignment. Alternatively, or in addition to the alignment system 28, a mechanical alignment arrangement can be used, including mechanical guides for directing the mobile mining machine 14 into the rapid charging station 11 to be positioned with the pick-up coils located aligned in signal coupling relation with the primary coils. The operator of the mobile mining machine 14 remains in position on the mobile mining machine 14 during the charging operation. When the battery 24 is charged, the operator continues with mining operations.

Rapid Charging Station

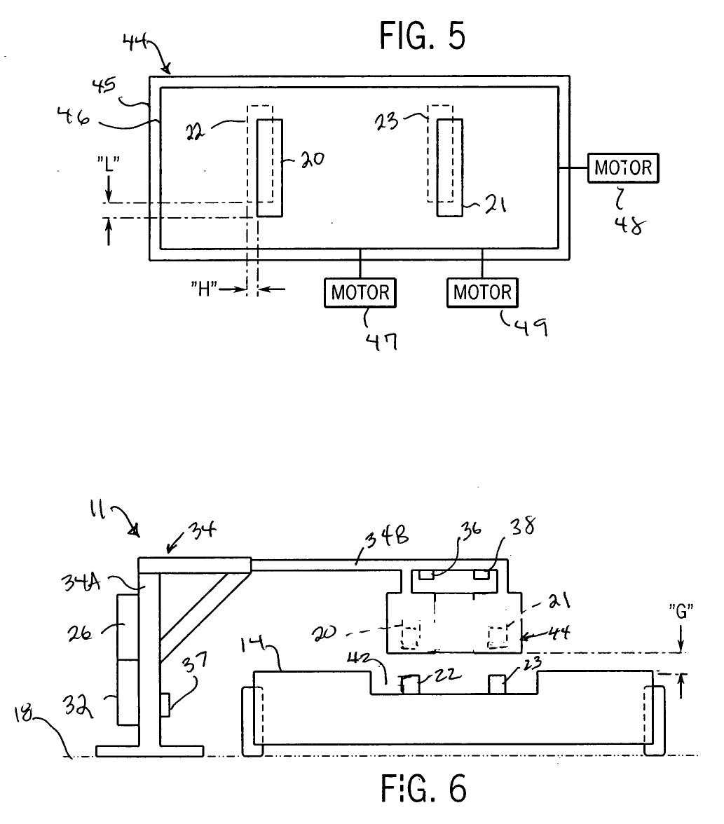

Referring to FIGS. 2, 5 and 6, considering the rapid charging station 11 in more detail, the support 34 mounts the primary coils 20 and 21 in a manner that allows the primary coils 20 and 21 to be accurately aligned with the inductive pick-up coils 22 and 23 on the mobile mining machine (MMM) 14 to optimize inductive power transfer during a battery charging operation. The support 34 can include a 3-dimensional position control mechanism 44, shown in FIG. 5, that includes a base 45 and a movable plate 46 supported on the base 45 for movement in three coordinates. The plate 46 carries the primary coils 20 and 21 for movement along “x”, “y” and “z” axes. Alternatively, the position control mechanism can provide movement in two coordinates in a horizontal plane and a portion of the support 34 can be movable vertically. While in a preferred embodiment the primary coils are supported in overlying relationship with the roadways, with modification as to the support and the mounting and location of the pick-up coils on the mobile mining machine, the primary coils can be located along side the roadway, or the support could be adapted to move the primary coils into signal coupling relation with the pick-up coils in such alternative locations.

In a preferred, non-limiting example, the primary coils 20 and 21 are accurately aligned with the pick-up coils 22 and 23 when there is an air gap “G” of at least about 10 mm between the pick-up coils 22 and 23 and the primary coils 20 and 21 and a spacing of ±50 mm in the horizontal (“H”) and longitudinal (“L”) directions to optimize inductive power transfer during a battery charging operation. These dimensions are a function of the size and configurations of the primary and pick-up coils and may vary accordingly. Alternatively, the alignment system 28 can include mechanical guides for providing the desired alignment between the primary coils and the inductive pick-up coils.

During charging operations, the primary coils are energized by AC current supplied to the primary coils by the power supply 26. The output of the power supply 26 is connected through cables 27 to the primary coils 20 and 21. By way of example, the power supply 26 can provide 30 Kw of charging power.

Sensors

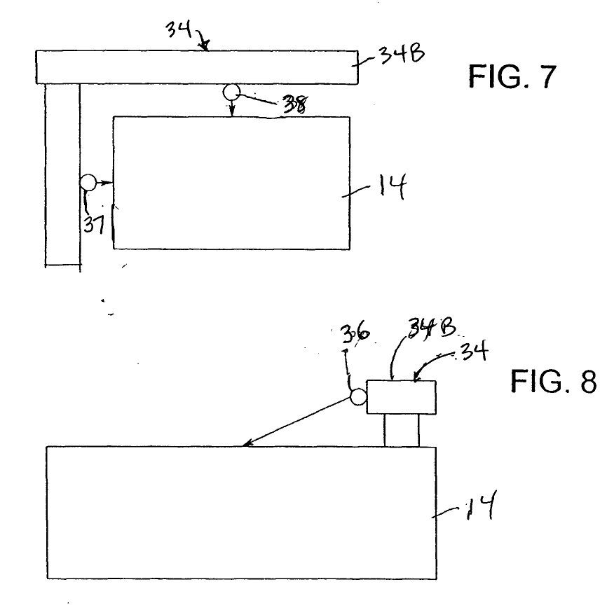

Referring to FIGS. 6, 7 and 8, the untrasonic sensors 35 include three sensors 36, 37 and 38. The sensors 36 and 38 can be located on the cantilever beam 34B the support 34, and the sensor 37 can be located on the vertical beam 34A of the support 34. The beam 34B can be located just slightly above the upper surface of the vehicle or the support can be configured to allow the beams 34B to pass within a channel or depression 42 that extends longitudinally along and centrally of the mobile mining machine 14 in order to provide the desired tolerance on the separation between the pick-up coils carried by the mobile mining vehicle and the primary coils supported by the support 34. The sensor 36 is used to produce a signal indicative of the longitudinal distance between a first point of reference defined by the support 34 and a point on the upper surface of the MMM 14 or a feature of the MMM 14. Also, while the sensor 38 is shown mounted on beam 34B near the front end of the mobile mining machine, the sensor 38 can be located on an extension (not shown) of the support 34 or the beam 34B, in a position to detect the front end of the MMM 14 or a feature of the MMM 14 that will allow the sensor 38 to produce an output signal indicative of the longitudinal location of the mobile mining machine relative to the rapid charging station 11. The sensor 37 is used to produce a signal indicative of the transverse or horizontal distance “H” between a second point of reference defined by the support 34 and a point on the side of the MMM 14. The sensor 38 is used to produce a signal indicative of the vertical distance “G” between a third point of reference defined by the support 34 (corresponding to the vertical height of the primary coils) and the pick-up coils on the upper surface of the MMM 14. The sensors 36-38 can be located within separate enclosures that are mounted on the support 34.

The signals produced by the sensors 36-38 provide three coordinates that are indicative of the location of the MMM 14 relative to the three points of reference defined by the support 34. In addition, the coordinates of the location of the pick-up coils 22 and 23 are known and the movable plate 46 carrying the pick-up coils 20 and 21 is returned to a default position at the end of each charging operation so that the coordinates of the primary coils 20 and 21 also are known. This information is used to generate command signals for the motors 40 for repositioning the plate 46 to align the primary coils with the pick-up coils. This allows for determining the position of the MMM 14 and thus the position of the pick-up coils carried by the MMM 14, including the distances from the rapid charging station to front, side and upper surfaces of the MMM 14.

The positioning motors 40 include three motors 47, 48 and 49 which are coupled to the plate 46 and driven by command signals provided by the controller 32 to position the plate 46, and thus the primary coils 20 and 21, relative to the pick-up coils 22 and 23 for providing optimal inductive power transfer from the primary coils to the pick-up coils.

Controller

The controller 32 is located at the rapid charging station 11 and uses sensed data to determine the location of the MMM 14 relative to the rapid charging station in effecting alignment of the primary coils with the pick-up coils. In addition, the controller 32 uses stored information and parameters related to operating conditions of the battery 24 of the MMM 14, including information provided to the controller 32 from the MMM 14 over a bidirectional RF link established between the RF modem 30 of the rapid charging station 11 and the RF modem 60 of the MMM 14, in providing automatic charging control of the operation of the MMM 14. Such information can include battery current, battery voltage, battery temperature, for example.

The stored information can include information relating the configuration of the MMM 14, for example. The operating information can include information about the configuration of the MMM 14. The controller 32 makes decisions based upon information obtained from sensors 36-38. The decisions are translated into actions, in particular, selective activation of the motors 40 for repositioning the plate 46, thereby repositioning the primary coils carried by the plate 46. Typically, the alignment takes only a few seconds.

Preferably, the charging cycle is initiated and controlled by the controller 32 of the rapid charging station 11. Alternatively, the controller 32 can also receive commands from the MMM 14, including a command to initiate a charging cycle via an RF link established by the remote radio modems 30 and 60. Charge time will be determined by the processor of the remote charging station based on the information fed back from the monitoring on the mobile mining machine.

The controller 32 includes a programmable logic controller (PLC) having a processor that is programmed to provide battery charging functions and operations. Many currently available PLCs can be used to perform the coil alignment function and control of the rapid charging operation. The PLC is programmed to monitor current conditions and make decisions very quickly. Alternatively, the controller 32 can include a processor that is operated under software control to provide the battery charging functions.

The inputs for the controller 32 include the output signals produced by the sensors 36-38 and communication signals received by the RF modem 30 from the MMM 14. In one embodiment, the sensors 36-38 include, but are not limited to ultrasonic distance measurement devices. The communication signals can include signals produced by the controller 57 of the MMM 14 indicative of battery parameters, such as battery voltage, current and temperature. Outputs provided by the controller 32 include command signals for the drive motors 40 and communication signals for the RF modem 30.

The controller 32 also includes a data structure or memory for storing received information as well as other data and information. The memory can also store information relating to sense outputs provided by the sensors 33-35. The PLC is programmed to monitor operator inputs and the sensor inputs and produce outputs for operating the machine, including driving and steering commands for the electrical components of the drive system of the MMM 14.

Mobile Mining Machine

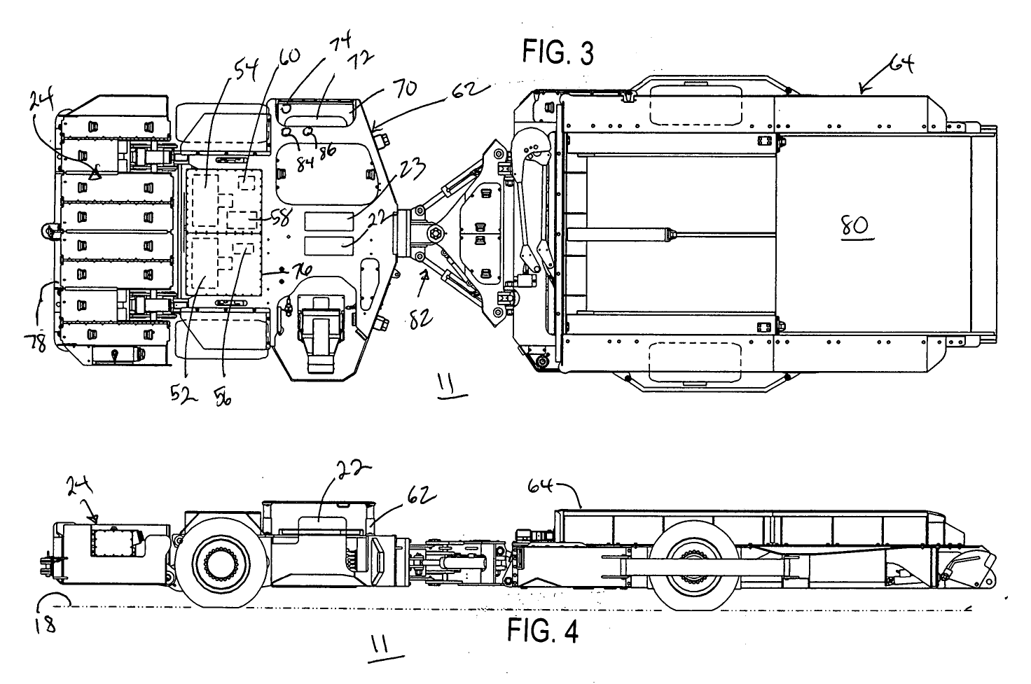

Referring to FIGS. 3 and 4, there is shown a battery-powered, mobile mining (MMM) 14 using opportunity battery charging in accordance with the present invention. The MMM 14 is used in mining applications in which the MMM 14 is driven along roadways in underground mines for carrying mined payloads or other loads.

Mobile Machine

The MMM 14 is of the tractor-trailer type, including a tractor portion 62 and a trailer portion 64 that is pivoted to and pulled by the tractor portion 62. The MMM 14 can be similar to the battery hauler vehicles commercially available from Oldenburg Group Incorporated, as model numbers BH10 and BH20, for example. However, it should be appreciated that the MMM 14 is an example of only one type of electrically powered vehicle that can use opportunity battery charging according to the present invention.

Operator Position

The tractor 62 includes an operator position or cab 70 from which the operator of the MMM 14 controls the operation of the MMM 14. The operator position 20 can include operator controls 72 for normal operation of the vehicle, including controls for start, stop, steering, speed of travel, braking, etc. The MMM 14 includes a standard display of the type used on all mobile mining machines of this type provides an indication of the level of battery charge available. In addition, an indicator light 74 indicates that a battery charging operation is in progress.

Components

The exposed inductive pick-up coils 22 and 23 are rigidly mounted in an accessible area on the MMM 14. Preferably, the pick-up coils, as well as the primary coils, are oriented with their longitudinal axis extending in the direction of travel of the mobile mining machine 14. Each pick-up coil can be approximately 26% the width of the mobile mining machine. The electronic control components can the monitoring circuit 56 which includes a controller 57 located at the operator position. The rectifiers 52 and 54, the monitoring circuits 56, the interface 58 and the radio modem 60 and associated electronics can be mounted in explosion proof enclosure 76 on the MMM 14.

Monitoring Circuits

The monitoring circuits 56 can include a programmable logic controller (PLC) and associated operator controls. The controller 57 can also provide normal machine control functions including start, stop, direction of travel, speed of travel, and hydraulic solenoid controls (steering, material ejection, machine vertical articulation, battery change circuitry, braking) under operator control, as is known.

The interface 58 provides a connection between the PLC of the monitoring circuits and the RF modem 60, for transmitting information, such as battery current, voltage and temperature, to the rapid charging station 11.

Battery

The battery 24 is located on the tractor 12, mounted at the front end of the tractor 12, and is comprised of a plurality of battery cells which can be located under protective covers 78. The battery 24 can be a 240 V lead acid battery, 875 amp hour or larger, depending on required payloads, 210 kW or larger, with an expected battery weight of 24,300 pounds. The battery is a 64 cell battery, providing 128 vdc. Alternatively, a 128 cell battery, providing 240 v, can be used. A substitute battery (64 cell or 128 cell battery) can be located, off of the mobile mining machine, at a remote battery charging station (not shown), to replace the battery 24 whenever a full “deep” charge of the battery 24 is to be provided. The tractor 62 can include battery changer apparatus similar to that disclosed in U.S. Pat. No. 5,598,083, to facilitate installation and removal of the battery 24 for “deep” charging the battery.

The trailer 64 includes a bed 80 for receiving material or components to be transported. The trailer 64 is coupled to the tractor 62 by a pivot mechanism 82. In addition, hydraulically operated control devices are mounted on the trailer 64. The hydraulically operated control devices can include a dumping mechanism as is known.

Operation

Referring to FIGS. 1 and 2, in order to rapid-charge the battery 24 on the MMM 14, the MMM 14 is driven into the area where the rapid charging station 11 is located and the inductive pick-ups on the MMM 14 are aligned with the primary coils at the charging station. The inductive pick-ups and the primary coils do not make physical contact. There is an air gap “G” of approximately 10 mm between the inductive pick-ups and the primary coils.

A communication signal is passed between the radio modem on the MMM 14 and the RF modem 30 on the rapid charging station 11. When charging cycles are initiated automatically by the controller 32 of the rapid charging station in response to coil alignment being achieved, the communication can be a signal for lighting an indicator light 74 to alert the operator that a charging cycle is in progress. When charging cycles are initiated by the operator from the MMM 14, this communication can be a start command transmitted from the MMM 14 to the rapid charging station 11.

During the charging cycle, electrical energy is coupled through the inductive pick-up coils 22 and 23, rectified by the rectifiers 52 and 54 and passed into the battery 24 on the MMM 14. The state of charge condition for the battery 24 can be determined by sensing battery voltage using the monitoring circuits 56. As the battery is discharged, the battery voltage decreases. As the battery is charged, the battery voltage increases. When the battery 24 is fully charged, the battery voltage will be the rated value, 128 vdc for the embodiment employing a 64 cell battery. When the battery is discharged the battery voltage will be about 80% of the rated voltage. The controller 32 will initiate and control a charging cycle based upon the information, including the value of battery voltage, that fed back via the RF communication link from the monitoring circuits 56 on the MMM 14. When the battery 24 has received the required charge, or at the end of a predetermined timing interval defined by the controller 32, the charging operation is terminated by the controller 32, and the operator causes the MMM 14 to resume moving in its normal operating mode.

The time that is required to charge the battery will vary depending on the size of the battery and the operating duty cycle of the mobile mining machine. The power transfer components of the opportunity charging system can provide battery charging times as low as twenty seconds. As stated above, the battery 24 is not fully charged, but will receive sufficient charge to extend the use time for the battery 24. The storage battery on the mobile mining machine is charged while the mobile mining machine is in operation. The mobile mining machine does not have to be turned off. Moreover, the mobile mining machine does not have to leave the production area of the section being mined and the operator of the mobile mining machine does not have to leave the operating position on the mobile mining machine during the charging operation.

Process Flow Diagram

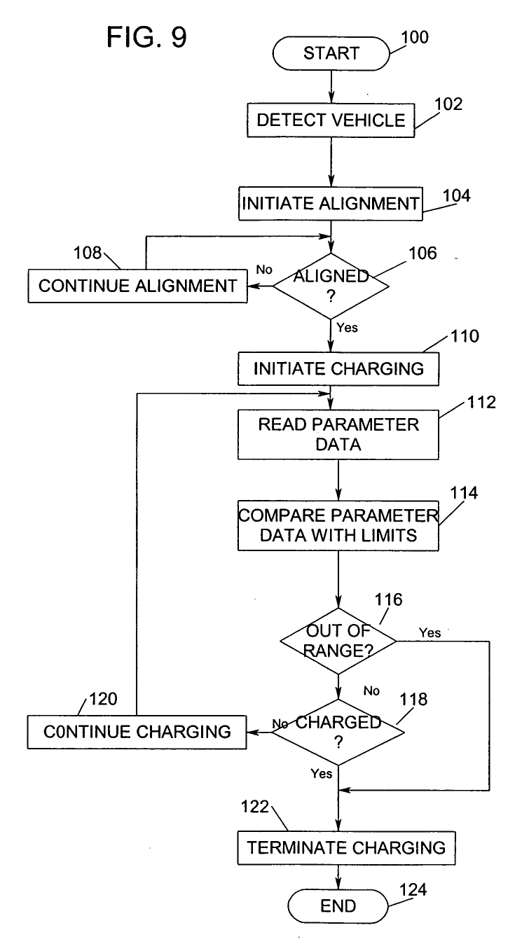

Reference is now made to FIGS. 2 and 6, along with FIG. 9, which is a process flow diagram for the controller 32 of the rapid charging station of the opportunity charging system in accordance with the invention. A battery charging operation is initiated in response to an MMM 14 being positioned in the rapid charging station 11. This is accomplished by the operator driving the MMM 14 into position below the support 34 with the pick-up coils 22 and 23 roughly aligned with the primary coils 20 and 21.

The process begins at the START Step 100 and in Step 102, the controller 32 detects the presence of the MMM 14 in the rapid charging station with the pick-up coils 22 and 23 roughly aligned with the primary coils 20 and 21. By way of example, an electronic signaling device 84 can be mounted on the MMM 14 to automatically alert the rapid charging station 11 as to the presence of the MMM 11. The signaling device 84 can transmit an RF signal which can be detected by the RF modem 30 of the rapid charging station, or by using the signaling device to cause the RF modem 60 on the MMM 14 to transmit a signal to the rapid charging station 11 via an RF communication link established between the RF modem 30 and the RF modem 60. This signaling functionality will distinguish between an MMM, such as MMM 14, seeking battery charging and people moving in the proximity of the rapid charging station 11. When the operator of the MMM 14 no longer wants the battery 24 to be automatically charged, the operator can temporarily disable the signaling device 84 by operating a switch 86 located at the operator's control position 72 to turn-off the signaling device on the MMM 14. Alternatively, the detection of the presence of MMM 14 can be made using one or more of the sensors 35. The outputs of the sensors 35 can be read periodically to determine when MMM 14 has moved into position in the rapid charging station 11, and stopped.

In Step 104, alignment of the primary coils 20 and 21 with the pick-up coils 22 and 23 is initiated. The controller 32 responds to the outputs of the sensors 36-38 to produce command signals for the motors 47-49 to move plate 46 for aligning the primary coils to be aligned with the pick-up coils.

Decision Step 106 determines if the primary coils are properly aligned with the pick-up coils. If the primary coils are not properly aligned with the pick-up coils, coil alignment is continued in Step 108. When decision Step 106 determines that the primary coils are aligned with the pick-up coils, flow proceeds to Step 110 in which a charging cycle is initiated by the controller 32. The controller 32 sends a signal to the MMM 14 to turn on the indicator light 74 to alert the operator of the MMM 14 that a charging cycle has been initiated.

In Step 110, the controller 32 causes the power supply 26 to supply AC current to the primary coils 20 and 21. The AC current is coupled inductively to the pick-up coils 22 and 23 and the resultant current is rectified by rectifiers 52 and 54 and applied to the battery terminals. In step 112, parameters of the battery 24, such as battery voltage, current and temperature, are monitored by the controller 57 of the MMM 14. Signals indicative of the values of the parameters being monitored are transmitted to the rapid charging station 11 by the RF communication link established between the RF modems 30 and 60.

In Step 112, the controller 32 stores the parameter data and in Step 114 compares the parameter data with setpoint data stored in memory. Decision Step 116 determines if any of the battery parameters is out of range. If none of the battery parameters is out of range, flow proceeds to decision Step 118 which determines if the battery 24 has received sufficient charge.

If Step 118, determines that the battery 24 has not received sufficient charge, the charging cycle is continued in Step 120 and flow repeats Steps 112-120. If step 116 determines any of the battery parameters is out of range, flow proceeds to Step 122.

When Step 118 determines that the battery has received sufficient charge, flow proceeds to Step 122 which terminates the battery charging cycle. The controller 32 sends a signal to the MMM 14 to turn off the indicator light 74. The controller 32 terminates the supply of AC current to the primary coils 20 and 21 and the battery charging operation is exited.

It may therefore be appreciated from the above detailed description of the preferred embodiment of the present invention that it provides an opportunity charging system for mobile mining machines.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

What is claimed is:

1. An opportunity charging system for a battery-powered mobile mining machine operating within a mine, the mobile mining machine including a battery, said opportunity charging system comprising:
at least one rapid charging station for charging the battery on the mobile mining machine using inductive power transfer, said rapid charging station located in an area of the mine along a roadway traveled by the mobile mining machine, said rapid charging station including
at least one primary coil;
a support for supporting said primary coil adjacent to a roadway over which the mobile machine travels;
a power supply for energizing said primary coil; and
a controller;
the mobile machine including
at least one pickup coil, said support allowing the mobile machine to be driven to a position adjacent to said primary coil that permits said pick-up coil to be located in signal coupling relation with said primary coil; and
a remote battery charging interface for allowing a communication link to be established between the mobile machine and said rapid charging station, said controller of said rapid charging station at least initiating battery charging cycles in response to information transmitted over said communication link.

2. The opportunity charging system according to claim 1, wherein said controller initiates and controls the charging cycle, and wherein the time duration of charging cycle is based upon information transmitted to said rapid charging station from the mobile machine over said communication link.

3. The opportunity charging system according to claim 2, wherein the mobile machine includes monitoring devices for monitoring parameters of the battery, said remote battery charging interface transmitting information representing monitored values for the parameters to said rapid charging system, and wherein said controller responds to said parameter information to interrupt the charging cycle.

4. The opportunity charging system according to claim 1, wherein said rapid charging station includes an alignment module for providing relative alignment between said primary coil said pick-up coil.

5. The opportunity charging system according to claim 4, wherein said rapid charging station includes first and second primary coils and the mobile machine includes first and second pick-up coils, and wherein said alignment module is operable to align said first and second primary coils with said first and second pick-up coils, respectively.

6. The opportunity charging system according to claim 4, wherein said alignment module includes a plurality of sensors for producing output signals indicative of the location of the mobile machine relative to said rapid charging station; and wherein said controller uses the output signals for aligning said primary coil with respect to said pick-up coil.

7. The opportunity charging system according to claim 1, wherein said battery charging interface includes a first signal modem and said rapid charging station includes a second signal modem, allowing a wireless communication link to be established between the mobile machine and said rapid charging station.

8. The opportunity charging system according to claim 1, and including an indicating device at an operator control location of the mobile machine, said indicating device controlled by said controller for providing an indication that a charging cycle is in progress.

9. An opportunity charging system for a battery-powered mobile mining machine operating within a mine, the mobile machine including a battery; said opportunity charging system comprising:
at least one rapid charging station for charging the battery on the mobile machine using inductive power transfer, said rapid charging station including
a primary coil;
a power supply for energizing said primary coil;
a support for supporting said primary coil in overlying relationship with at least a portion of a roadway over which the mobile machine travels;
a controller; and
an alignment module;
the mobile machine including
a pick-up coil mounted on an upper surface of the mobile machine, said support allowing the mobile machine to be driven to a position beneath said primary coil that permits said pick-up coil to be located in signal coupling relation with said primary coil; and
a remote battery charging interface allowing a communication link to be established between the mobile machine and said rapid charging station, wherein said controller of said rapid charging station at least initiates battery charging cycles in response to information transmitted over said communication link.

10. The opportunity charging system according to claim 9, wherein said controller initiates and controls the charging cycle, and wherein the time duration of charging cycle is based upon information transmitted to said rapid charging station from the mobile machine over said communication link.

11. The opportunity charging system according to claim 9, wherein the mobile machine includes monitoring devices for monitoring parameters of the battery, the mobile machine include a first signal modem and said rapid charging station including a second signal modem, allowing said communication link to be established between the mobile machine and said rapid charging station, and wherein signals coded to represent monitored values for the parameters are transmitted over said communication link from the mobile machine to said rapid charging station.

12. The opportunity charging system according to claim 11, wherein said controller responds to the coded signals to terminate the charging cycle in response to a value of at least one of said parameters.

13. The opportunity charging system according to claim 9, wherein said rapid charging station includes first and second primary coils and the mobile machine includes first and second pick-up coils, and wherein said alignment module is operable to align said first and second primary coils with said first and second pick-up coils, respectively.

14. The opportunity charging system according to claim 9, wherein said alignment module includes a plurality of sensors for producing output signals indicative of the location of the mobile machine relative to said rapid charging station; and wherein said controller uses the output signals for aligning said primary coil with respect to said pick-up coil.

15. The opportunity charging system according to claim 14, wherein said alignment module further includes a member for movably supporting said primary coil, said member supported for movement in three coordinates, and a plurality of position devices coupled to said member, said controller responsive to the output signals for generating drive signals for said positioning device to cause said positioning devices to move said member in at least one of said coordinates to align said primary coil relative to said pick-up coil.

16. A method for providing opportunity charging of a battery of a battery-powered mobile mining machine operating within a mine, the mobile machine including a battery; said method comprising the steps of:
providing at least one rapid charging station for charging the battery on the mobile machine using inductive power transfer, wherein the charging station includes a primary coil and a power supply for supplying current to the primary coil;
supporting the primary coil in overlying relationship with at least a portion of a roadway over which the mobile machine travels;
providing a pick-up coil on the mining machine;
coupling the pick-up coil to terminals of the battery through a rectifier circuit;
driving the mining machine into the charging station to locate the pick-up coils in close proximity with the primary coil;
detecting the presence of the mining machine in the charging station;
automatically initiating a charging cycle in response to detection of a mining machine in the charging station;
monitoring at least one parameter of the battery; and
terminating the charging operation when the parameter reaches a predetermined value.

17. The method according to claim 16, and including the step of aligning the primary coil and the pick-up coil prior to initiating the charging cycle.

18. The method according to claim 17, wherein the step of aligning the primary coil and the pick-up coil includes displacing one of said coils relative to the other one of said coils.

19. The method according to claim 17, wherein the step of aligning the primary coil and said pick-up coil includes mounting said primary coil on a three-dimensional position control mechanism to allow said primary coil to be moved along three axes.

20. The method according to claim 16, including the steps of transmitting radio frequency signals communication link between the mobile machine and the rapid charging station, and using the radio frequency signals to initiate and terminate the charging cycle.
